(19) United States
(12) Patent Application Publication
(10) Pub. No.: US 2005/0049920 A1
(43) Pub. Date: Mar. 3, 2005

(54) System for tracking nutritional content of food purchases

(76) Inventors: Robin Day, Montreal (CA); Maggy Warda, Montreal (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/651,146

(22) Filed: Aug. 29, 2003

(51) Int. Cl. G06F 17/60

(52) U.S. Cl. 705/15

(57) ABSTRACT

A personal nutrition system is disclosed. The system uses data collected during the purchase of food items at a grocery store or over the Internet. The system tracks the dietary purchase history of a consumer and determines rates of consumption for a variety of different nutrients. Based upon these rates of consumption and goals provided by the consumer, the system suggests changes to the diet both in terms of rates of consumption and alternative food items. Data collected by the system is optionally provided to a third party which use the data to provide highly targeted marketing and consumer incentives.

### FIELD OF THE INVENTION

The invention relates to systems for acquiring data relating to consumer purchase behavior and more specifically to tracking that data and providing information based upon it.

### BACKGROUND

Maintaining a healthy lifestyle is easier for some people than others. Many individuals put forward a considerable effort to maintain a desired weight. It is well known that diet has a considerable effect on weight loss. Every year, people spend tremendous amounts of money on their diet and the management of their diets. Unfortunately, many people are unable to control their weight to their own satisfaction.

A wide variety of books have been published that suggest certain dietary behavior. All such diets involve a person planning their intake of food and not deviating from their plan. Some people will diet with the aid of a computer database. Thus, a user provides information relating to their diet to the computer database and the computer database will indicate if the user is likely to be deficient in critical nutrients based upon the data. This method serves as the basis of a wide variety of prior art devices and methods.

In U.S. Pat. No. 5,836,312, by Moore, filed 2 Jan. 1996, a system is provided that adjusts the effect of consumable intakes on physiological parameters. The system tracks items that are consumed and compares them to the physiological parameters of the user. The system then informs the user of suggested changes. The system takes the age, height and, build into consideration when determining if certain parameters are not being properly met.

In U.S. Pat. No. 5,412,564 by Ecer, filed 3 Feb. 1994, a system and method of diet control is disclosed. The system disclosed by Ecer involves scanning the bar codes of food items or receiving keyboard entry information in addition to a weight reading and storing the corresponding data on a smart card. Later, the smart card is scanned and the data is provided to a personal computer. The personal computer maintains a database of food products and a record of the purchases of the user. Additionally, the personal computer is able to provide a daily average nutritional consumption of the user. Since most grocery products are scanned when they are purchased, a record of the purchasing history of the user is updated every time the user purchases food at a grocery store. The prior art of Ecer stores this data and maintains it on a smart card for the user. One disadvantage of the system is that it will only inform the user of their behavior after the purchase. This system allows a user to verify that they have purchased food items that are appropriate to their diet. In the event that the user has purchased food that is not appropriate for their diet it is unlikely that the user will be informed of their poor purchases until the user reviews the data on the smart card. Unfortunately, this would typically occur after the purchase, transportation and storage of the groceries. At that point it is not helpful to inform the user that they have made bad purchases. Indeed, unless the user proactively modifies their diet or returns their groceries then this system will likely be ineffective in dietary intake control.

In U.S. Pat. No. 5,478,989 by Shepley, filed 13 Apr. 1993, a nutritional information system is disclosed. This prior art system teaches a shopping cart with a card reader. The system allows a user to determine the nutritional data of an item by scanning the bar code of the item and then deciding whether or not to purchase the food item. Unfortunately, implementing this system involves buying a bar code scanner, card reader and a computer for storing a database for a shopping cart. These items are not inexpensive. Indeed, if every shopping cart in a grocery store is to be equipped with one then the cost of the system will be prohibitive unless it is adopted by a substantial portion of the customers of the store. Additionally, when one food item is scanned it is difficult to judge whether this item is appropriate to a diet without a comprehensive knowledge of the rest of the diet.

In U.S. Pat. No. 6,246,998 filed 25 Feb. 1999, Matsumori teaches a system of ordering groceries via the Internet. Specifically, the system according to Matsumori provides useful information regarding the purchase. This information includes a description of what environmental needs the food has, the size of the food item, as well as nutritional information. The system according to Matsumori is clearly intended to provide a user with a notion of how much food they are buying. This is useful in that it will help to prevent the user from buying food that needs to be refrigerated when the user has insufficient space available in their refrigerator. While this prior art collects nutritional information it merely presents it to the user. The data is not presented in any specific context and no suggestion of any use of the nutritional information is provided.

In U.S. patent application 2003/0004831 Owens teaches a system that supports the purchase of groceries using an Internet connection. A key feature of this system is that a user provides an entire grocery list to the system and the system determines a range of different total prices associated with the list of articles. This system also suggests food items based upon the diet plans of the user. Further, the system supports the viewing of nutritional labels for food items prior to the purchase of the food items. Another aspect of the Owens prior art is the sale of consumer purchase history information to food retailers and food manufacturers as well as providing consumer incentives, in the form of coupons, when the user is prepared to purchase groceries. Unfortunately, this system is only applicable to purchasing groceries over the Internet. While this may be very beneficial for some people, most people purchase their groceries in person at a grocery store, while others optionally use both Internet purchases and conventional grocery store purchases.

It would be beneficial to provide a dietary intake monitoring system that proactively assists a user in purchasing food appropriate to a proposed diet of the user. Ideally such a system will be easily operated and proved at a low cost.

### SUMMARY OF THE INVENTION

The invention describes a method of tracking food purchasing history comprising:
providing identifier data relating to at least a food item;
providing user identification data corresponding to a user;
purchasing the food item;
storing storage data on a server, the storage data derived from the identifier data and the user identification data, the server having an Internet connection;
providing the storage data to the user via the Internet connection; and,
providing nutritional data associated with the storage data.

Additionally, the invention teaches a nutritional data tracking system comprising:
a bar code reader for reading bar coded information provided on a food item;
a personal authentication device for verifying an identity of a purchaser of at least a food item;
a first computing device for providing a data record corresponding to the identity of the purchaser and the least a food item;
a commerce device for processing a purchase the at least a food item; and,
a computer server for receiving the data record from the first computing device and storing the data record, the computer server having a communication port for communicating with other computers via an Internet connection, the computer server having access to a nutrition database, the nutrition database for providing nutrition data corresponding to food item data stored within the data record.

### BRIEF DESCRIPTION OF THE DRAWINGS

The invention is now described with reference to the figures in which:

FIG. 1 is a schematic diagram of an embodiment of the invention supporting the purchase of groceries at a grocery store;

FIG. 1a is a schematic diagram of an embodiment of the invention in which a user accesses data on a personal computer;

FIG. 1b is a schematic diagram of an embodiment of the invention in which nutritional data associated with food items is not sent to the grocery store computer;

FIG. 2 is a schematic diagram of an embodiment of the invention supporting the purchase of groceries via the Internet;

FIG. 2a is a schematic diagram of an embodiment of the invention supporting the purchase of groceries either at a grocery store or via the Internet; and,

FIG. 2b is a schematic diagram of an embodiment of the invention supporting the purchase of groceries via the Internet in which the food purchase data is not routed through a central server.

### DETAILED DESCRIPTION OF THE INVENTION

As described by Ecer (U.S. Pat. No. 5,412,564) a detailed record of every food purchase is generated when people buy food. Ecer takes advantage of the information to record what has been purchased and determine a total nutritional intake based upon this information. Clearly, the use of smart cards by Ecer introduces a cost to the system that prevents adoption of the system.

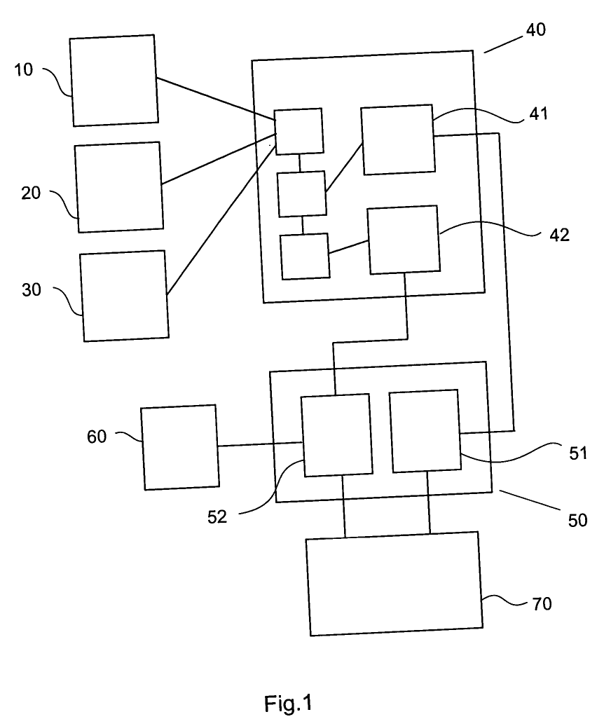

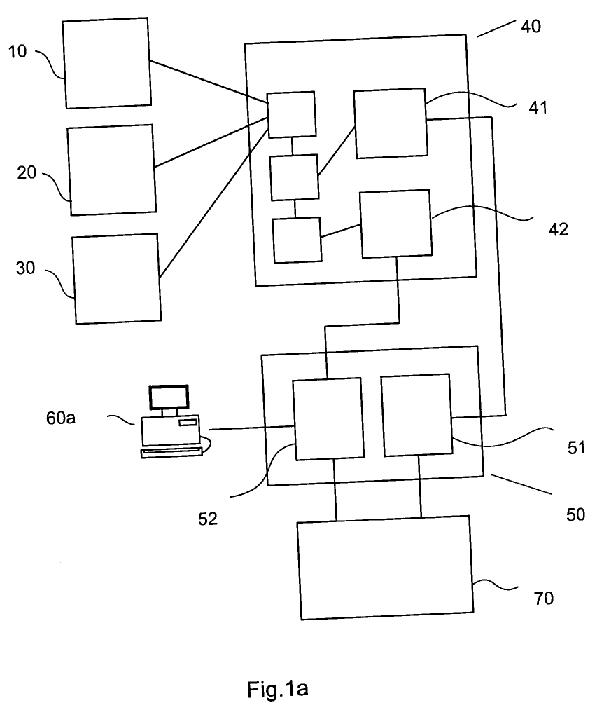

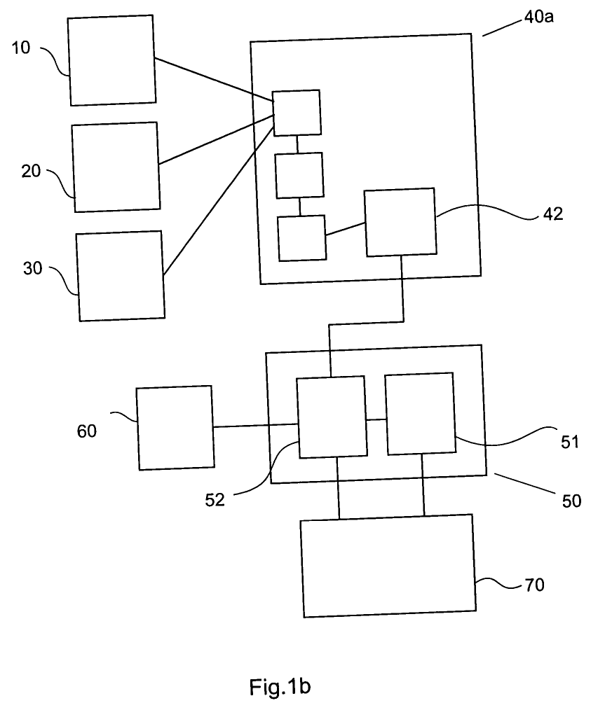

Referring to FIG. 1a schematic diagram of a system according to a first embodiment of the invention is shown. FIG. 1 includes: a customer identification reader (ID reader) 10; a bar code reader 20; a food quantity reader 30; a food outlet computer 40; a central server 50; a remote user system 60 and a remote management system 70. The food outlet computer 40 has a secondary nutritional database 41 and an in-store customer purchases database 42. The central server 50 has a food items database 51 that has comprehensive nutritional data and a customer purchases database 52. In use, a consumer brings a series of food items to a check out counter. Data associated with the food items is recorded in a food outlet computer 40. It is suggested that the data be provided to the food outlet computer 40 via one of the bar code reader 20 and the food quantity reader 30. The bar code reader 20 scans a bar code displayed on packaging of a food item. Alternatively, the food quantity reader 30 uses a scale to measure the weight of the food being purchased. The food quantity reader 30 also includes a keyboard for receiving product codes associated with the food item being weighed. For example, apples will have one product code while oranges have another. The bar code reader 20 and food quantity reader are commonly used in many grocery stores already. A food record is generated and stored in the in-store customer purchases database 42. The food record includes an identifier for the food item, and nutritional information associated with the food item. The nutritional information is provided by the secondary nutrition database 41. Optionally, the food record includes a weight of the food item. Once the food record has been completed the customer provides an identity input to the identification reader 10. Once the groceries have been purchased, the food outlet computer 40 produces a data record. This data record includes a list of all the food items purchased, nutritional information regarding the food items and ID reader data. The data record is then stored at the central server in the customer purchases database 52. The user is then able to access the customer purchases database 52 remotely with a remote user system 60.

Optionally, the user copies data from the data record to the remote user system 60. Since it is likely that data relating to food items will change in response to recipe changes and the addition of new food products a remote management system 70 is provided to make such changes to the food item database 51. This updated information is then provided the secondary nutrition database 41. In the event that an error is perceived by the system, for example, a food item is purchased however there is no nutritional database entry in the food item database 51 for it then a message is provided to the system administrator via the remote management system 70.

After the purchase of food items, the user accesses the remote user system 60. The remote user system 60 receives at least a portion of the data record from the customer purchases database 52 regarding nutritional information associated with recent food purchases. The portion from the data record is used to create a report. This report includes a list of food item purchases by the user and nutritional data indicative of, for example, the total amount of sugar, carbohydrates and dietary fiber in the last purchase. Clearly, a wide variety of different nutritional data are optionally provided. The user is easily able to configure the remote user system 60 to provide the nutritional data that they desire. Additionally, the food items are optionally ranked based upon their contribution of a specific nutrient. The customer purchases database 52 provides a series of records regarding the previous purchasing history of the user and is therefore able to estimate a rate of consumption for a given food item or food items of a same group. For example, a first user buys ajar of jam roughly once per month. A second user buys on average three jars of jam per month. A third user buys one very large jar of jam every two months. Even though the users only buy one jar of jam in a given visit to the grocery store, the consumption rate of jam for the users is different. Since the system according to the invention tracks the previous purchases of the user it is able to estimate the rate of consumption of jam and any other food item. Optionally, the system is sufficiently sophisticated to group certain products together. For example, the system optionally groups brand-A strawberry jam and brand-B strawberry jam in the same group. If the user has a history of buying brand A and not brand B jam then the system will assume that the rate of consumption brand B jam will be equivalent to the rate of consumption of brand A jam should the user purchase brand B. Further, the system will optionally estimate the rate of consumption of jam is consistent whether the user buys strawberry jam or raspberry jam.

Since the system has consumption rate information available to it, it is able to make useful recommendations to the user regarding changes in the diet of the user based upon the dieting objectives provided by the user. Similarly, the system is able to evaluate the success of previous dieting recommendations by maintaining a record of previous recommendations it has provided and their effect on purchasing behavior. For example, if a user states that they wish to reduce their fat intake and the system suggests substituting sherbet for ice cream, the system will provide a different recommendation if the user continues to buy ice cream. The different recommendation is optionally based on cutting fat in other areas of the diet, making another substitution for ice cream, reducing the consumption rate of ice cream or a combination of these options. In this case, the consumption rate of fat for each food item the user purchases will play a role in determining what recommendations are made.

The remote user system 60 also receives other data provided by the user. For example, if the user eats at a restaurant then the user may provide data associated with what was eaten. Clearly, this data will likely not be as accurate as the data associated with data record as described with reference to FIG. 1 however it is useable in determining an approximate intake of nutrients. Clearly, a variety of devices support the remote user system 60. For example, personal computers and personal digital assistants are useable as remote user systems 60. Alternatively, the grocery store has a computerized kiosk that supports the functions of the remote user system 60. Additionally, the remote user system 60 supports an option for assigning a personal consumption percentage to a given food item. Thus, if the user has a party and provides food then the user will likely consume a portion of those food items associated with the party. The remote user system 60 provides messages suggesting food item substitutions when prompted by the user. Thus, the user receives these messages from the remote user system 60 at a time proximate a time associated with the purchase of food items. Optionally, the remote user system 60 is a portable wireless computing device and the user brings it to the grocery store. Thus, the remote user system 60 is accessed when the user is buying groceries and therefore is able to provide dietary recommendations when they are not likely to be forgotten.

Since the customer purchases database 52 maintains a longer-term record of the food purchase history of the buyer it is a simple matter to track anomalies in the diet. For example, identifying food allergies is often a long and unpleasant task. If the buyer should suspect they have a food allergy then the data associated with their food purchase history will be highly beneficial in identifying which food the buyer is allergic to and which foods the buyer is not allergic too.

In many cases dieters have tremendous difficulty is changing their behaviour regarding nutritional intake. Using a system according to the first embodiment of the invention it is a simple matter to gradually change the behaviour of the dieter and therefore it is more likely that the dietary objectives of the user will be achieved. Additionally, the slow change in diet will be easier to conform to in the longer term. For example, many people are able to lose a significant amount of weight by suddenly reducing their food intake and typically limiting themselves to very specific foods. Such a diet is often referred to as a “crash diet”. This type of diet is considered to be very unhealthy as certain vital nutrients are likely to be neglected. The system according to the invention is able to avoid this problem by monitoring a wide variety of nutritional information, not merely one or two nutritional criteria specified by the user.

Referring again to FIG. 1 a simple embodiment of the invention is illustrated. A person of skill in the art will envision a wide variety of alternative embodiments of the invention. Referring to FIG. 1a, a second embodiment of the invention is shown. FIG. 1a shows a system featuring a plurality of elements that are functionally equivalent to elements of FIG. 1 and have the same numeral. In this embodiment the remote user system 60 is a personal computer 60a. The personal computer 60a has an Internet connection and is able to transfer data to and from the central server 50. Thus, the personal computer 60a is able to store large amounts of data thereby eliminating the long-term storage of information in the customer purchases database. Additionally, since the personal computer 60a is able to store a large database, the nutrition database is optionally stored by the personal computer 60a instead of the food outlet system computer 40. Beneficially, this reduces the flow of information from the food outlet computer 40 to the central server 50.

Referring to FIG. 1b, a third embodiment of the invention is shown in which no nutrition database is present in the food outlet computer 40. Unlike the embodiments of the invention of FIG. 1 and FIG. 1a, an embodiment of the invention is shown in which the data record produced by the food outlet computer 40a is created absent any nutritional information. The food items data is all stored on the central server and data relating to the food items purchased is added to a data record at the central server 50 after the food items have been purchased. The data record produced by the food outlet computer 40 is created absent any nutritional information. Clearly, this embodiment of the invention will work with a variety of different remote user systems 60, such as a personal digital assistant and a personal computer.

Using a system according to the first embodiment of the invention provides a wide variety of benefits to the user, grocery stores and the food suppliers. Since the data associated with each food product is tracked it is a simple matter to determine if a particular food product was provided inadvertently. For example, if a shipment of meat is contaminated the system according to the first embodiment of the invention will be able to provide useful information regarding whether or not the user is at risk. Although this type of food recall is rare there is increasing concern that the food supply may be subject to terrorist attack and therefore the ability to track food items and inform the user of the food items in a timely manner is highly beneficial. In this way, an automated warning system provides a warning message to the buyer when a food item is known to be dangerous. Such an automated warning system optionally provides an email message informing the user of the possible danger however it is suggested that the system provide a telephone call to any of the buyer's residence, work place or cellular telephone. Thus, if a cookie manufacturer makes a peanut free cookie however the cookies are somehow contaminated with peanut products, such as peanut shavings or peanut oil, then using a system consistent with the second embodiment of the invention it is a simple matter to inform the affected consumers. Optionally, the users provide the system with a medical profile. The medical profile includes medical data associated with known medical conditions associated with dietary intake. Using such a system consumers who are allergic to peanuts are already known and therefore the vast majority of consumers who use the program need not be informed with a same urgency. This is also of use in determining if a person is, for example, lactose intolerant.

Additionally, it is a simple matter to securely provide food purchasing data to food manufacturers and retailers. For example, a company can identify a specific purchasing behaviour and provide relevant product information and incentives to the user. For example, if the user is trying to reduce their fat intake and they buy mayonnaise then a competing mayonnaise manufacturer is able to provided focused advertising to the user regarding the amount of fat in their product in comparison with the amount of fat in the product that the user normally buys. As an added incentive the competing mayonnaise manufacturer optionally provides a purchasing incentive, such as a coupon to the user. If the user only buys one container of mayonnaise every two months then the purchasing incentive is provided to the user at a time, for example, one week prior to their expected purchase of mayonnaise. This allows a very precisely directed marketing effort to be made. In comparison it is very wasteful to provide coupons to everyone within an area with no real certainty of whether or not the recipient will use them, or even if the coupons will be remembered when the recipient goes to purchase the item. Similarly, the food retailer is able to target their advertising at the customer of rival food retailers. Additionally, restaurants are able to advertise to people who demonstrate a tendency to purchase certain food items. For example, someone who consistently purchases fresh cilantro, basil and green curry is likely to enjoy going to a Thai restaurant. Optionally, in order to maintain the privacy of the user, the data associated with the user is sent absent any identifiers of the user, such as their name, address or email address. In this case, the data is sent with encrypted user identification data and whenever the manufacturer wishes to provide goods or messages to the user a request is made to a third party. The third party receives the goods or messages and provides the necessary user location information. Thus, the user is able to maintain the level of privacy that they desire while receiving buying incentives. Clearly, the personal and dietary information need only be available to other people and companies if the user authorizes it.

Clearly, food consumption data is a useful sales and marketing tool to others who do not produce food. For example, a dieter might be inclined to purchase books on dieting or recipe books specifically intended to support a specific type of diet. Additionally, companies that sell sports and exercise equipment will be able to target their advertising more effectively also.

Optionally, the user does not specify dietary criteria but instead uses the service to find the best prices for food items. In this case, after the transaction is completed an email message is provided to the user by a competing grocery store. The competing grocery store states a cost difference between what was paid and what would have been paid had the user bought groceries from the competitor. In order to maximize the impact of such an advertisement the competitor provides the amount over a series of grocery purchases, instead of only one.

In U.S. Pat. No. 6,430,539 B1 by Lazarus et al. consumer spending behaviour data is recorded and a predictive modeling system is used for marketing purposes. This system associates groups of consumers and targets them for promotional materials and consumer incentives. Clearly, this is inferior to targeting a specific consumer for specific promotional material and specific consumer incentives because it is highly unlikely that any two consumers have identical purchasing behaviours.

The use of data associated with consumer spending behaviour is well known. For example Wong et al. in U.S. Pat. No. 6,119,933 filed 16 Jul. 1998 discloses a method and apparatus for consumer loyalty and marketing analysis. Specifically, Wong et al. describes a system that keeps track of customer-buying behaviour and provides a reward in points to encourage customers to participate in the system. Additionally, Wong et al. teach the maintenance of a database for collecting all customer data at a regular interval. Clearly, such a system depends on a desire on the part of the consumer to participate. The benefit to the consumer is a reward program. In comparison, the system according to an embodiment of the invention provides the consumer with a useful service. Indeed, many people make a significant effort to regulate their diet and save money on groceries. However, it would be a simple matter to introduce a reward-based system according to Wong et al. within the system according to the invention.

Many consumers would appreciate less advertising and promotional materials. A system according to the invention supports such a reduction. The system facilitates advertising that is more accurately focused. Consequently, once a system according to the invention is introduced there will likely be less need for generic advertising to random recipients. For example, consumers with no history of purchasing a specific item, such as beef will be less likely to receive advertising for beef and beef products. Additionally, a second set of consumers who do consume beef will receive the advertising for it however, if this second set of consumers do not change their beef purchasing behaviour in response to the advertising then it will become immediately apparent that the advertising is ineffective. Once such behavioral patterns have been established, the advertising effort and expense need not be wasted on specific consumers to whom it does not work. Therefore, a system according to the invention permits highly focused advertising to individual consumers who are most likely to take an interest in the product described by the advertisement. In this way, the system is highly beneficial to the consumer and advertisers.

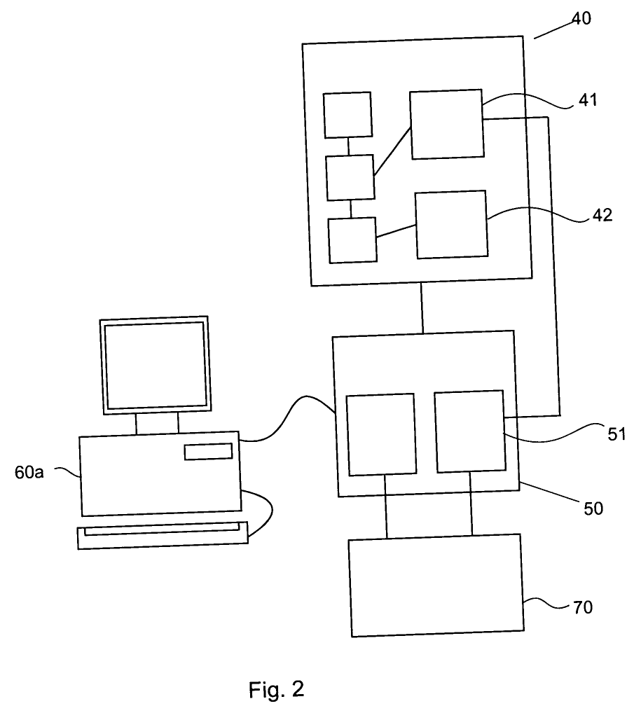

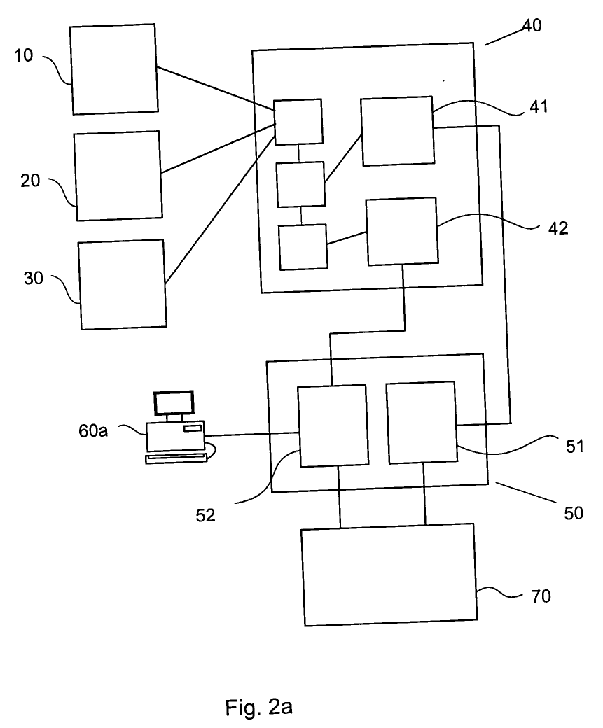

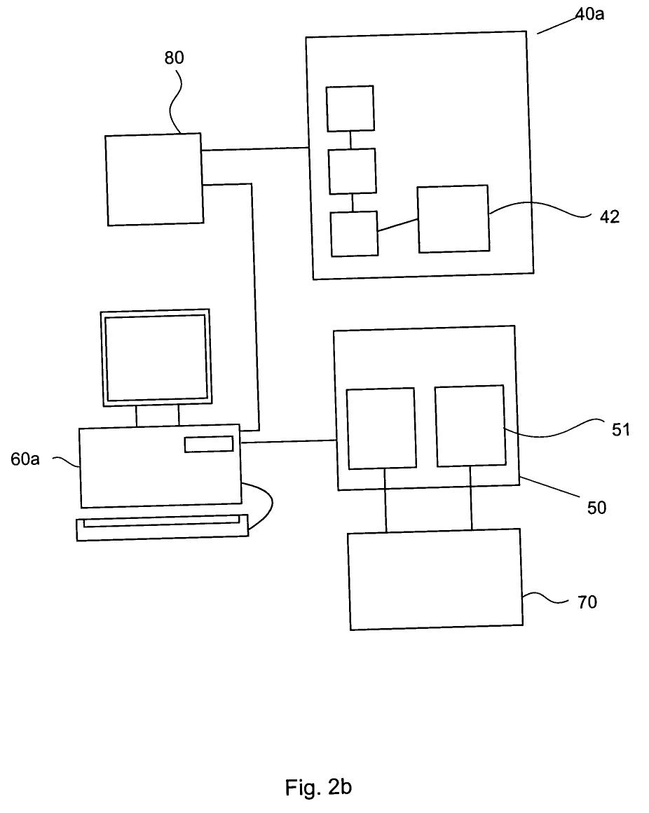

Referring to FIG. 2, an embodiment of the invention supporting the purchase of food items over the Internet is provided. The system comprises a personal computer 60a having an Internet connection: a central server 50, and a food outlet computer 40. In use, a user creates a user profile including dietary objectives. The user initiates a shopping session and then provides data corresponding to a shopping list to the personal computer 60a. Optionally, a portion of the shopping list is based upon another shopping list that has been stored in a previous shopping session. If the user has created a new user profile then previous shopping lists may not be available for comparison to the new shopping list. A wide variety of options exist to deal with this problem. In a first mode of operation, the system optionally makes no recommendations until a suitable purchasing history is established. In this way, the user is able to continue their eating behaviour. As described with reference to FIG. 1, a key advantage of the system according to the invention is that changes in the diet of the user optionally occur very slowly. Although this may not produce immediate results that the user may desire, it is likely to produce a diet that will be more easily sustained in a longer term. Alternatively, the system queries the user for data associated with a consumption rate for the items on the shopping list. In another mode of operation, the system provides a sample diet to the user, the sample diet is chosen based upon the preferences and physiology of the user. The user optionally makes changes to the suggested shopping list.

The personal computer estimates a set of consumption rates for food items on the shopping list and optionally suggests suitable alternatives for individual food items based upon the estimated consumption rates; nutritional data associated with food items on the shopping list and dietary objectives of the user. The user then chooses to accept the suggestions provided by the personal computer 60a, ignore the suggestions or make their own substitutions. When the shopping list is changed the personal computer 60a uses an algorithm to evaluate the new shopping list and, optionally, the personal computer 60a provides new suggestions. Once the user has decided on the shopping list, the shopping list is provided to the central server 50. The central server 50 then provides the shopping list along with user identification information to the food outlet computer 40. The shopping list is then processed. Later, the items on the shopping list are delivered to an address associated with the user identification. Optionally, data associated with spending behaviour of the user is recorded in a memory of the central server 50. This data describes the items purchased, their quantity and the date. This data is useful to the manufacturers of the food items as well as the user. If the user authorizes the distribution of their shopping lists then the manufacturers optionally provide targeted advertising to the users. Such advertising optionally includes purchasing incentives, such as a coupon or rebate for a food item. Clearly, in this embodiment of the invention, the purchasing incentive should be delivered electronically to minimize costs.

This embodiment of the invention is particularly beneficial because it permits highly proactive dietary recommendations. Using this system, the user is informed of their dietary choice when they are ready to purchase food. It is not necessary to inform the user of such a choice before the initiation of such an Internet grocery purchasing session. Additionally, any purchasing incentives are also provided at the time of the food purchase. Beneficially, an information purchasing incentive is provided to the user. The information purchasing incentive describes a specific food product and why it is a better choice for the consumer. The dietary objectives of the user and the purchasing history of the user are both used to target the information purchasing incentive. For example, some purchasers are very price conscious while others are very diet conscious. Thus, an information purchasing incentive will optionally target the user based upon criteria that are important to the user as determined by their stated objectives and their purchasing history.

A consumer will optionally purchase food at a grocery store or using an Internet service in dependence upon a variety of factors. Referring to FIG. 2a, a schematic diagram of a system according to the invention supporting both Internet shopping and conventional shopping is shown. Items having the same numeral representation that is the same as an item in FIG. 1 and FIG. 2 are equivalent. In use, the user creates an account and a set of data corresponding to the account is stored on the central server 50. The account includes information associated with the dietary objectives of the user and personal authentication data of the user. A central server 50 maintains a data record associated with purchases of food by the user. The purchase of food optionally involves the user going to a grocery store, however the system also supports the purchase of food via an Internet connection. When the user wishes to purchase food item via the Internet connection, the user will provide a list of desired food items from the personal computer 60a to the customer purchases database 52. Data associated with the food list is used to generate a data record. This data record is stored on the customer purchases database 52. The food list is then sent to a food outlet computer 40.Whether the food is purchased via the Internet connection or during a visit to the grocery store, the data records maintained on the central server 50 are equivalent. Thus, the user is free to purchase food and track their nutrition intake. This is highly advantageous for a user who wishes to purchase food via the Internet but is unable to do so, for example, while on vacation. Optionally, a restaurant provides a data record to the customer purchases database in response to the purchase of a meal by the user. This simplifies the collection of nutritional data for the user and additionally provides all the nutritional data to the user via data records on the customer purchases database 52. In an alternative embodiment of the invention, the data record is not generated until the food outlet has processed the food order. Thus, if the user orders and pays for 600 grams of Macintosh apples, the data record will read the measured mass of the Macintosh apples, for example 643 grams, that are sent to the user. This is beneficial in that it provides more accurate data.

Referring to FIG. 2b, a schematic diagram of a system for purchasing groceries supporting Internet shopping according to an embodiment of the invention is shown. Items having the same numeral representation that is the same as an item in FIG. 1 and FIG. 2 are equivalent. The diagram includes an Internet appliance 80 for supporting data transfer between the personal computer 60a and the food outlet computer 40. In this embodiment of the invention, food purchasing data is transferred to the personal computer 60a absent the food purchasing data being provided to the central server 50. The central server maintains a database of food items and corresponding nutritional data regarding the food items. In a first mode of operation, food purchasing data is provided from the personal computer 60a to the central server 50. The central server 50 then provides nutrition data associated with the nutritional properties of the food corresponding to the food purchasing data. This nutrition data is provided to the personal computer 60a. Alternatively, the personal computer 60a maintains a database of food items and their corresponding nutritional information and determines nutrition data upon receiving a set of food purchasing data. In either case, transferring nutrition data and food purchasing data separately makes the system far more robust. For example, if the central server 50 is temporarily unavailable then there is no pooling of data at the central server 50. Similarly, although only one central server 50 is shown it will be apparent to one of skill in the art of Internet data transfer that such a system will support a plurality of central servers. This is highly beneficial in that the system according to FIG. 2b is easily upgraded. Additionally, only one Internet appliance 80 is shown however there are likely to be a variety of data paths available between the food outlet computer 40 and the personal computer 60a.

The embodiments of the invention described herein include a central server that stores nutrition data associated with food items in addition to purchase history data. Clearly, the nutrition data need not be stored in a server that also stores purchase history data. Numerous other embodiments of the invention will be apparent to those of skill in the art without departing from the spirit and scope of the invention.

1. A method of tracking food purchasing history comprising:
providing identifier data relating to at least a food item;
providing user identification data corresponding to a user;
purchasing the food item;
storing storage data on a server, the storage data derived from the identifier data and the user identification data, the server having an Internet connection;
providing the storage data to the user via the Internet connection; and,
providing nutritional data associated with the storage data.

2. A method of tracking food purchasing history according to claim 1 wherein the step of providing identifier data incorporates a bar code scanner.

3. A method of tracking food purchasing history according to claim 1 wherein the step of providing electrical identifier data incorporates receiving a first input signal from a keyboard and receiving a second input signal relating to a weight of the food item.

4. A method of tracking food purchasing history according to claim 1 wherein the step of providing the nutritional data to a user comprises:
establishing a communication link between the server and a personal digital assistant; and,
providing the nutritional data to the personal digital assistant via the communication link.

5. A method of tracking food purchasing history according to claim 1 wherein the step of providing the nutritional data to a user comprises:
establishing a communication link between the server and a personal computer; and;
providing the nutritional data to the personal computer via the communication link.

6. A method of tracking food purchasing history according to claim 1 wherein the step of providing the nutritional data to a user comprises:
establishing a communication link between the server and a personal computer;
providing the storage data to the personal computer via the communication link; and,
using the personal computer to compare the storage data with a nutrition database to provide the nutritional data.

7. A method of tracking food purchasing history according to claim 1 comprising the steps of:
comparing a list of ingredients relating to a food item against a medical profile of the user; and,
informing the user of any conflicts resulting from the step of comparing.

8. A method of tracking food purchasing history according to claim 7 wherein the step of informing the user comprises providing a telephone message.

9. A method of tracking food purchasing history according to claim 1 comprising the steps of:
providing data relating to a recalled food item to the server;
determining if the user has purchased the recalled food item; and,
upon determining that the user has purchased a recalled food item, informing the user of any recalled food items purchased.

10. A method of tracking food purchasing history according to claim 9 wherein the step of informing the user comprises providing a telephone message.

11. A method of tracking food purchasing history according to claim 1 comprising the step of determining a predicted consumption period associated with a specific food item of the at least a food item.

12. A method of tracking food purchasing history according to claim 11 wherein the step of determining a predicted consumption period comprises retrieving date data associated with a previous purchase of a food item related to the specific food item.

13. A method of tracking food purchasing history according to claim 12 comprising determining a consumption rate of a nutrient in dependence upon nutrition data and the predicted consumption period.

14. A method of tracking food purchasing history according to claim 13 comprising receiving a set of target nutrient consumption rates from a user.

15. A method of tracking food purchasing history according to claim 14 wherein the set target nutrient consumption rates is a range of consumption rates for a specific nutrient.

16. A method of tracking food purchasing history according to claim 15 comprising providing a message to the user when a determined consumption rate is not within the range of consumption rates for a specific nutrient.

17. A method of tracking food purchasing history according to claim 14 comprising determining a range of consumption rates based upon the target nutrient consumption rate; and,
comparing the range of consumption rates with a determined consumption rate.

18. A method of tracking food purchasing history according to claim 17 comprising upon determining that the determined consumption rate is not within the range of consumption rates, providing a message to the user when the determined consumption rate is not within the range of consumption rates.

19. A method of tracking food purchasing history according to claim 17 comprising determining an estimated consumption rate of a nutrient based upon suggested food items in the suggested food list and an estimated consumption period; and,
verifying that the absolute difference between an estimated consumption rate and the target nutrient consumption rate is less than absolute difference between the determined consumption rate and target nutrient consumption rate.

20. A method of tracking food purchasing history according to claim 19 comprising the step of upon successful result in the step of verifying, providing the suggested food item list to the user.

21. A method of tracking food purchasing history according to claim 17 comprising determining an estimated consumption rate of a nutrient based upon suggested food items in the suggested food list and an estimated consumption period; and,
verifying that the estimated consumption rate is within the range of consumption rates.

22. A method of tracking food purchasing history according to claim 21 comprising upon successful result in the step of verifying, providing the suggested food item list to the user.

23. A method of tracking food purchasing history according to claim 11 comprising providing a consumer incentive to a user in dependence upon the consumption period associated with the specific food item.

24. A method of tracking food purchasing history according to claim 23 wherein the consumer incentive is provided to the user at a time dependent upon the consumption period associated with the specific food item and a time of a previous purchase of the specific food item.

25. A method of tracking food purchasing history according to claim 23 wherein the consumer incentive relates to the specific food item.

26. A method of tracking food purchasing history according to claim 23 wherein the consumer incentive relates to a food item related to the specific food item.

27. A nutritional data tracking system comprising:
a bar code reader for reading bar coded information provided on a food item;
a personal authentication device for verifying an identity of a purchaser of at least a food item;
a first computing device for providing a data record corresponding to the identity of the purchaser and the least a food item;
a commerce device for processing a purchase of the at least a food item; and,
a computer server for receiving the data record from the first computing device and storing the data record, the computer server having a communication port for communicating with other computers via an Internet connection, the computer server having access to a nutrition database, the nutrition database for providing nutrition data corresponding to food item data stored within the data record.

28. A nutritional data tracking system according to claim 27 wherein, the computer server is for storing medical data of the user.

29. A nutritional data tracking system according to claim 28 wherein the medical data comprises data associated with food allergies.

30. A nutritional data tracking system according to claim 29 wherein the computer server informs a user of a conflict between the medical data and the data record.

31. A nutritional data tracking system according to claim 29 wherein the computer server informs a user of a food recall in dependence upon the data record and the medical data.

32. A nutritional data tracking system according to claim 29 wherein the computer server informs a user of a food recall in dependence upon the data record.

33. A nutritional data tracking system according to claim 27 comprising a personal computer having an Internet connection wherein personal computer receives the data record from the computer server via the Internet.

34. A nutritional data tracking system according to claim 33 wherein the personal computer is for storing a data record of medical information of the user.

35. A nutritional data tracking system according to claim 34 wherein the medical information comprises data associated with food allergies.
